(19) United States
(12) Patent Application Publication
(10) Pub. No.: US 2006/0147785 A1
(43) Pub. Date: Jul. 6, 2006

(54) Fuel cell

(75) Inventors: Shu-Ching Chiang, Hsinchu (TW); Jar-Lu Huang, Hsinchu (TW); Yi-Yie Yan, Hsinchu (TW); Hsin-Sen Chu, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/269,689

(22) Filed: Nov. 9, 2005

(30) Foreign Application Priority Data
Dec. 30, 2004 (TW) 93141516

(51) Int. Cl. H01M 2/08; H01M 8/10

(52) U.S. Cl. 429/35; 429/30

(57) ABSTRACT

A fuel cell is comprised of a pair of bipolar plates and a membrane electrode assembly sandwiched between the bipolar plates disposed in parallel. A hard stopper is disposed between the two bipolar plates to prevent the two bipolar plates from over-squeezing the membrane electrode assembly. The stopper can be formed by thickening the bipolar plates or in an appropriate region on the membrane electrode assembly. The gap between the components of the fuel cell is controlled within an appropriate range, instead of too narrow or too wide. This helps improving the performance of the fuel cell.

This Non-provisional application claims priority under 35 U.S.C. § 119(a) on Patent Application No(s). 093141516 filed in Taiwan on Dec. 30, 2004, the entire contents of which are hereby incorporated by reference.

### BACKGROUND OF THE INVENTION

1. Field of Invention

The invention relates to a fuel cell and, in particular, to a fuel cell with a fixed gap.

2. Related Art

The structure of a proton exchange membrane fuel cell consists of two bipolar plates 10 and a membrane electrode assembly (MEA) 20 sandwiched in between, as illustrated in FIG. 1. The material of the bipolar plate 10 has to have good conductivity (e.g., graphite) with the design of a flow channel 11. The MEA 20 is disposed on the surface of a proton exchange membrane (PEM) 21, such as the Nafion polymer material coated with a catalyst 22 and a gas diffusion layer (GDL) 23. The GDL 23 is usually made of a porous material for the gas to easily pass through. A common choice is the carbon fabric or carbon paper.

The electricity generation principle of the fuel cell is the combination of hydrogen and oxygen gases to produce water, heat, and electricity. When a fuel with the hydrogen gas is guided into an anode flow channel, the gas penetrates through the holes of the GDL to the surface of the electrode, followed by decomposition into electrons and protons. The electrons are guided out for further use, whereas the protons are combined with water molecules in the water-rich environment. More explicitly, the protons penetrate through the PEM and react with the oxygen molecules on the anode to form water.

For the reaction to happen, the hydrogen molecules on the anode and the oxygen molecule on the cathode should be in contact with the electrodes as much as possible. During the assembly of the fuel cell, an external force F has to be imposed to fix the entire fuel cell set. Therefore, each pair of adjacent cells 30 is in close contact to achieve air-tight and low resistance effects, as shown in FIG. 2. However, the imposed pressure may not be evenly distributed to each single cell 30 because of tiny errors during the assembly. In that case, the components of the single cell 30, including the bipolar plates, GDL, and electrodes, will be under different pressures. In the end, the gaps between the components of each single cell 30 in assembled fuel cell set are different.

If some single cell has a too wide gap in the fuel cell set, the air-tightness of the cell is insufficient such that gas may leak out of the gap, particularly when the gas is under some unusual pressure. Once the gas leaks out, not only can it leak into the environment, the gas may even short the anode and the cathode. In that case, the cell performance will reduce or may even burn out.

Secondly, a too wide gap reduces the contact area between the GDL and the bipolar plates inside the cell, resulting in higher contact electron impedance. Since the GDL often uses a porous carbon fabric or paper, its carbon fibers are woven into a plane. The contact force of the GDL with its adjacent bipolar plate differs with the contraction and contracting force of the carbon fabric or paper. The contraction of the GDL increases with the pressure. The contraction is also proportional to the contact area between the carbon fibers of the GDL and the bipolar plate. When the contraction is large, the contact area increases and the contact impedance is reduced. This can mitigate the influence of the high contact impedance between the GDL and the bipolar plate.

FIG. 3 shows the experimental result of the cell performance under different contractions (equivalent to the contraction of the GDL). At the same current, the cell voltage increases with the contraction of the GDL. Obviously, the increase in contraction promotes the cell performance. A too wide gap, on the other hand, reduces the performance of the fuel cell. However, there is an upper limit in the contraction of the GDL. A too large contraction does not improve the performance of the cell, but reduces it instead.

Moreover, a too narrow gap will over-squeeze the holes in the GDL, which in turn hinders the gas passage. In that case, it is difficult for the gas to penetrate the GDL and reach the catalyst layer (CL). Besides, over-squeezing will also deform soft components such as the gasket too much, resulting in its elasticity fatigue and reducing the cell lifetime. Deforming the gasket too much may also break MEA or block the flow channel. Accumulating the deformations of many cells is likely to break the brittle bipolar plates, causing such serious problems as gas leaking or shorting the anode and cathode. All these problems will induce instability in the fuel cell set.

### SUMMARY OF THE INVENTION

In view of the foregoing, a primary objective of the invention is to provide a fuel cell that can maintain its gap to improve the performance of an assembled fuel cell set and each fuel cell thereof. To achieve the above objective, the disclosed fuel cell is comprised of a first bipolar plate, a second bipolar plate, a membrane electrode assembly (MEA), and a stopper. The first bipolar plate and the second bipolar plate are disposed in parallel, with the MEA and the stopper inserted in a gap formed in between. The stopper is disposed at the border of the MEA. Its thickness is slightly smaller than the MEA. Therefore, the stopper can maintain the gap between the first bipolar plate and the second bipolar plate, and controls the pressure of the first bipolar plate and the second bipolar plate on the MEA.

Besides, based upon the above idea, the stopper of the disclosed fuel cell can be formed by extending from the second bipolar plate toward the first bipolar plate. Thus, a partial region of the fist bipolar plate is thickened.

Moreover, another fuel cell disclosed by the invention is comprised of a first bipolar plate, a second bipolar plate, a MEA, and a stopper. The first bipolar plate and the second bipolar plate are disposed in parallel, with the MEA and the stopper inserted in a gap formed in between. The stopper is formed by extending the MEA. Thus, a part of the MEA is thickened. The stopper can maintain the gap between the first bipolar plate and the second bipolar plate is fixed, and controls the pressure of the first bipolar plate and the second bipolar plate on the MEA.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is a schematic view of the basic structure of a proton exchange membrane fuel cell in the prior art;

FIG. 2 is a schematic assembly diagram of the fuel cell set in the prior art;

FIG. 3 shows the influence of the gap in the fuel cell (contraction of the GDL) on the cell performance at different H₂ dew point in the prior art;

FIG. 4 is a schematic cross-sectional view of the first embodiment of the invention;

FIG. 5 is a schematic cross-sectional view of the second embodiment of the invention;

FIG. 6 is a schematic cross-sectional view of the third embodiment of the invention;

FIG. 7 is a schematic cross-sectional view of the fourth embodiment of the invention;

FIG. 8 is a schematic view of using a hard stopper and a gasket or o-ring according to the invention; and

FIG. 9 is a schematic view of using a stopper formed by thickening the bipolar plate and a gasket or o-ring according to the invention.

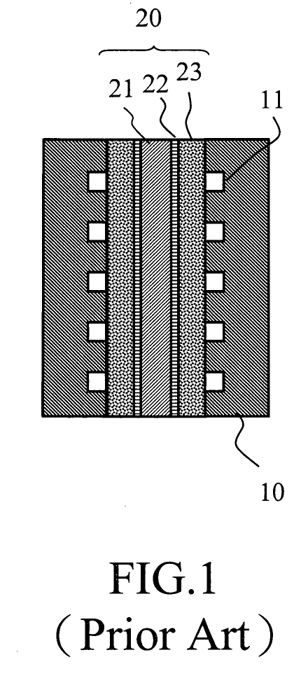

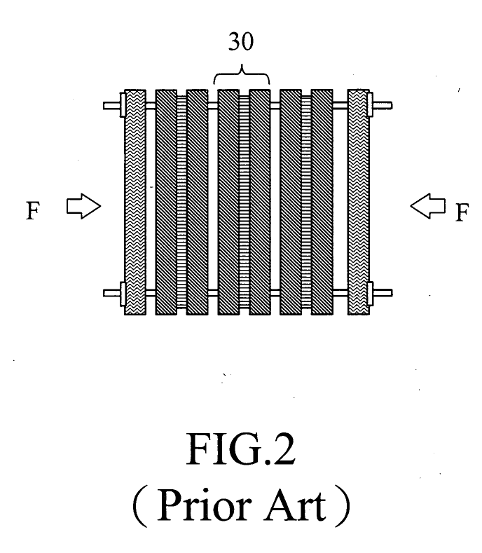

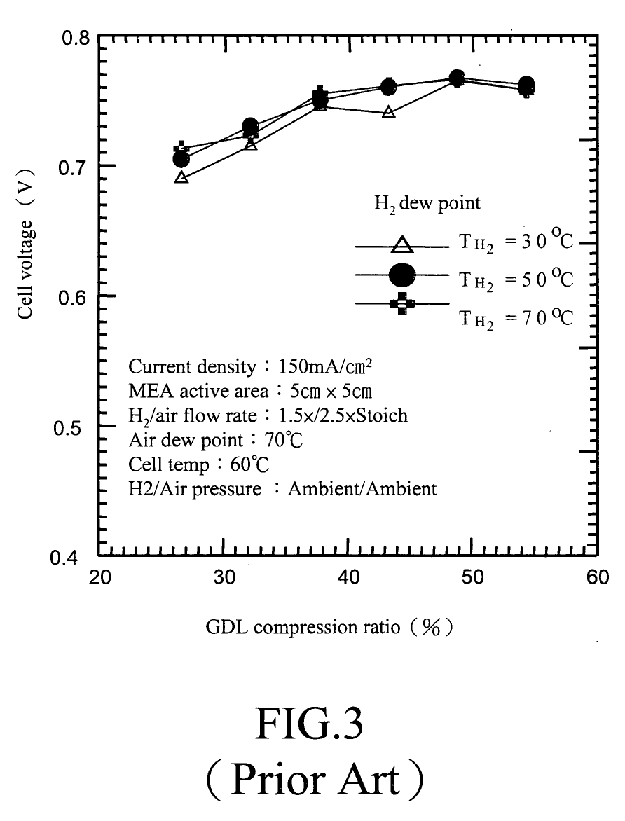

### DETAILED DESCRIPTION OF THE INVENTION

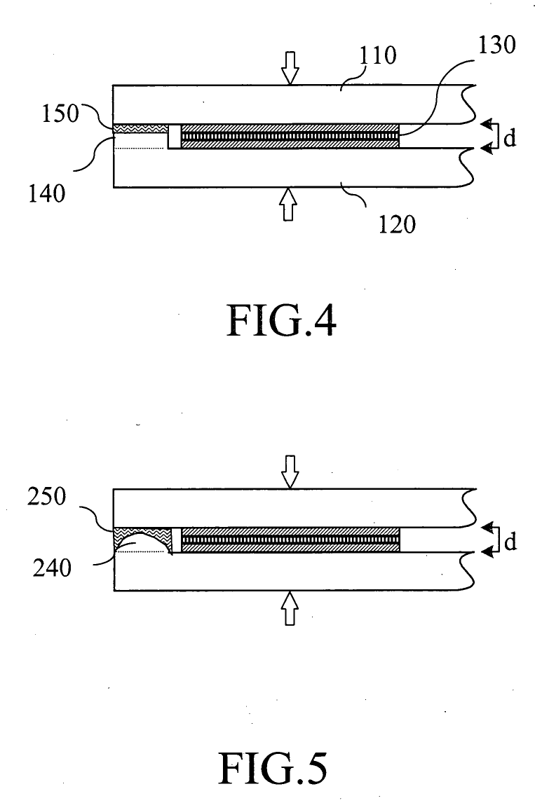

As shown in FIG. 4, a fuel cell according to the invention is comprised of a pair of parallel bipolar plates 110, 120 and an MEA sandwiched 130 between the bipolar plates 110, 120. Moreover, a stopper 140 is formed by extending the border of the bipolar plate 120 toward the other bipolar plate 110. The thickness of the border of the bipolar plate 120 increases. The stopper 140 is disposed around the MEA 130, and its thickness is slightly smaller than that of the MEA 130. When an external force is imposed to fix the entire fuel cell, the other bipolar plate 110 presses against the stopper 140, preventing the bipolar plates 110, 120 from over-squeezing the MEA 130. The gap d between the bipolar plates 110, 120 is controlled within a fixed range.

In this embodiment, the stopper 140 is formed by extending the bipolar plate 120. Therefore, to prevent the stopper 140 from directly touching the other bipolar plate 110, the fuel cell here is further coated with an insulating layer 150 between the stopper 140 and the other bipolar plate 110. Thus, the stopper 140 is insulated from the other bipolar plate 110.

Secondly, the stopper 140 in the current embodiment is an object with a rectangular cross section formed to surround the MEA 130. However, in practice, the stopper may have some other shape. As shown in FIG. 5, the stopper 240 in the second embodiment of the invention is a surrounding object with a curved surface. The stopper 240 is also coated with an insulating layer 250 to provide the required insulation effect.

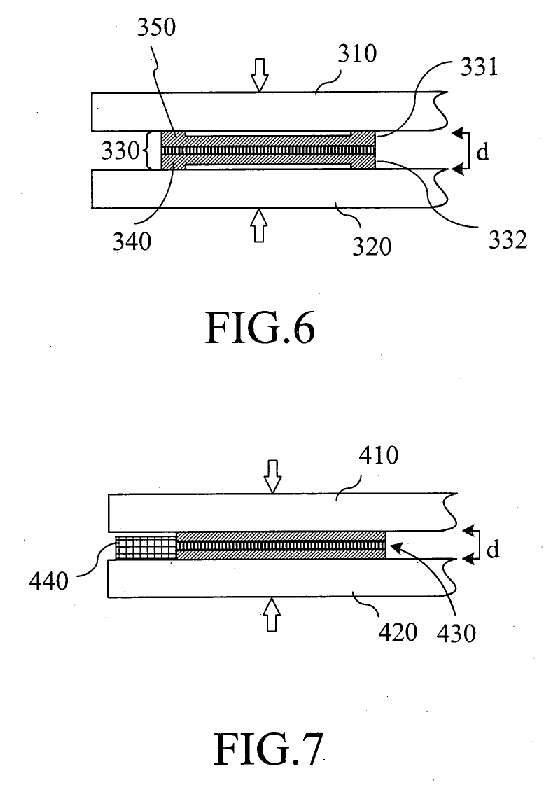

In yet another embodiment of the invention, an appropriate region of the MEA is thickened to form the stopper. As shown in FIG. 6, the fuel cell according to the third embodiment of the invention includes a pair of bipolar plates 310, 320, a MEA 330, and stoppers 340, 350 formed by thickening the GDL's 331, 332 of the MEA 330. The stoppers 340, 350 are formed at the borders of the GDL's 331, 332 of the MEA 330, toward the bipolar plates 310, 320 in a symmetric way. When an external force is imposed to fix the fuel cell, the two bipolar plates 310, 320 squeeze the MEA 330. The thickened portions (i.e., the stoppers 340, 350) of the GDL's 331, 332 of the MEA 330 control the gap d between the two bipolar plates 310, 320 within an appropriate range.

Moreover, as shown in FIG. 7, the fuel cell in a fourth embodiment of the invention includes a pair of parallel bipolar plates 410, 420, a MEA 430 sandwiched in between, and a hard stopper 440 directly disposed at the border of the MEA 430 and between the two bipolar plates 410, 420. When an external force is imposed to fix the fuel cell, the stopper 440 is squeezed by the bipolar plates 410, 420. Since the stopper 440 has very little or no deformation, it can control the gap d between the two bipolar plates 410, 420.

In this embodiment, the stopper 440 can be a ring pad disposed around the MEA 430. In practice, anything that can withstand squeezing without much deformation can be used to make the stopper.

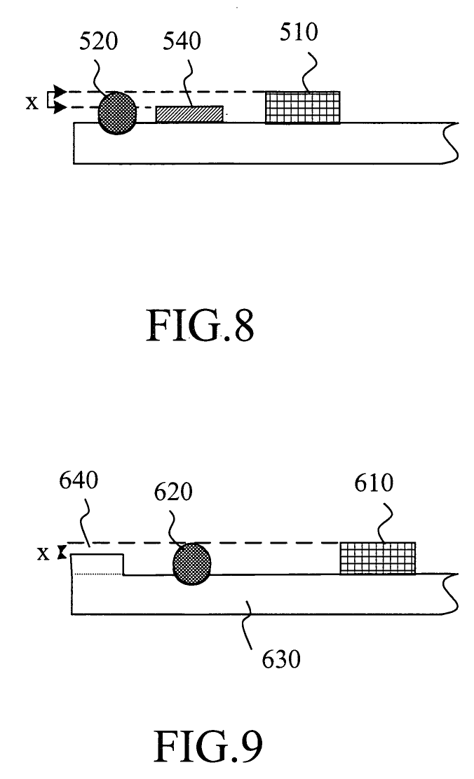

As shown in FIG. 8 and FIG. 9, each of the above-mentioned embodiments can use other sealing structures according to different flow channel designs and assembly methods. For example, one may use a gasket or o-ring as the stopper. The hardness of the gasket or o-ring has to be smaller than that of the bipolar plates, and the hardness of the stopper has to smaller than or equal to that of the bipolar plates in order not to damage the fuel cell. When the gaskets 510, 610 or o-rings 520, 620 are deformed by squeezing, the stopper 640 formed by thickening the bipolar plate 630 or the hard stopper 540 can control the contraction x of the MEA. It prevents the sealing structure from deforming so much that the MEA is squeezed or the gas flow channel is blocked, thereby reducing the performance of the fuel cell.

In the first to third embodiments, the stopper can be formed by injection molding directly on the bipolar plate or the GDL of the MEA. Alternatively, as in the fourth embodiment, the stopper can be prepared at the same time of inserting the gaskets or o-rings (e.g., in an injection molding process). This can reduce the number of steps in subsequent cell assembly.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A fuel cell, comprising:
a first bipolar plate and a second bipolar plate disposed in parallel to form a gap;
a membrane electrode assembly (MEA) inserted in the gap between the first bipolar plate and the second bipolar plate; and
a stopper disposed in the gap between the first bipolar plate and the second bipolar plate and around the MEA;
wherein the thickness of the stopper is smaller than the thickness of the MEA so that the first bipolar plate and the second bipolar plate are mediated by the stopper to maintain the gap thereof, thereby controlling the pressure on the MEA by the first bipolar plate and the second bipolar plate.

2. The fuel cell of claim 1, wherein the stopper is formed by an injection molding method.

3. The fuel cell of claim 1, wherein the stopper is formed by extending the second bipolar plate toward the first bipolar plate.

4. The fuel cell of claim 3 further comprising an insulating layer disposed between the stopper and the first bipolar plate.

5. The fuel cell of claim 1, wherein the stopper is a ring pad.

6. The fuel cell of claim 1 further comprising a sealing structure inserted in the gap between the first bipolar plate and the second bipolar plate and around the stopper and the MEA to increase the air-tightness of the MEA between the first bipolar plate and the second bipolar plate.

7. The fuel cell of claim 6, wherein the sealing structure is a gasket.

8. The fuel cell of claim 6, wherein the sealing structure is an o-ring.

9. The fuel cell of claim 1, wherein the stopper is a surrounding object with a rectangular cross section.

10. The fuel cell of claim 1, wherein the stopper is a surrounding object with a curved surface.

11. A fuel cell, comprising:
a first bipolar plate and a second bipolar plate disposed in parallel to form a gap;
a membrane electrode assembly (MEA) inserted in the gap between the first bipolar plate and the second bipolar plate; and
a stopper formed by extending the MEA and thickening a part of the MEA;
wherein the gap between the first bipolar plate and the second bipolar plate is maintained by the stopper, thereby controlling the pressure on the MEA by the first bipolar plate and the second bipolar plate.

12. The fuel cell of claim 11, wherein the stopper is formed by an injection molding method.

13. The fuel cell of claim 11, wherein the stopper is a surrounding object formed by extending the border of the MEA outward.

14. The fuel cell of claim 13, wherein the MEA extends out two of the stoppers symmetrically from the MEA toward the first bipolar plate and the second bipolar plate.

15. The fuel cell of claim 11 further comprising a sealing structure inserted in the gap between the first bipolar plate and the second bipolar plate and around the MEA to increase the air-tightness of the MEA between the first bipolar plate and the second bipolar plate.

16. The fuel cell of claim 15, wherein the sealing structure is a gasket.

17. The fuel cell of claim 15, wherein the sealing structure is an o-ring.
